(19) United States
(12) Patent Application Publication
(10) Pub. No.: US 2008/0110478 A1
(43) Pub. Date: May 15, 2008

(54) FILTER CLEANING APPARATUS CAPABLE OF CLEANING A FILTER WITHOUT DISMANTLING FILTER

(76) Inventor: Chin-Shien Huang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/611,896

(22) Filed: Dec. 18, 2006

(30) Foreign Application Priority Data
Nov. 10, 2006 (TW) 095141695

(51) Int. Cl. B08B 3/00

(52) U.S. Cl. 134/44

(57) ABSTRACT

The invention provides a filter cleaning apparatus having a driving force generating module, a driving force delivering module, and a cleaning module. The driving force generating module is for generating a driving force, the cleaning module is for cleaning a filter, and the driving force delivering module is coupled to the driving force generating module and the cleaning module for delivering the driving force from the driving force generating module to the cleaning module. In this way, the cleaning module is capable of moving on a surface of the filter to achieve the objective of cleaning the filter without dismantling the filter.

### BACKGROUND OF THE INVENTION

1. Field of the Invention

The present invention relates to a filter cleaning apparatus, and more particularly, to a filter cleaning apparatus capable of cleaning a filter without dismantling the filter.

2. Description of the Prior Art

Dust co-exists with us in our everyday environment. The surfaces of most objects will be covered with dust if the objects remain still or are used for a period of time without cleaning-the blades of an electrical fan, for example, become covered with dust. This can result in decreasing the operational efficiency of the object or damage to the components if the dust enters the machine. Taking a printer for example, the print quality may be degraded if the mechanism of the printer does not operate well due to dust, so a filter is often installed for preventing the dust from entering into the machine. But if the filter is not cleaned for a long period of time it will also become covered with dust, degrading the heat dissipation effect of the print machine and affecting the normal operation of the printer mechanism. Therefore, the filter is required to be cleaned regularly.

However, opening the external housing of the machine directly then dismantling or cleaning the filter will result in not only external dust invading the machine but also dust from the filter falling into the machine; therefore, dismantling and/or changing the filter is very inconvenient. Conventional filter cleaning methods include collecting the dust on the filter using a means similar to that of a vacuum cleaner, and rolling out the original filter and replacing it with a clean filter. For a user, the above-mentioned conventional filter cleaning methods, however, are inconvenient and costly.

### SUMMARY OF THE INVENTION

It is therefore one of the objectives of the present invention to provide a filter cleaning apparatus to keep the filter clean and prevent the dust from easily falling from the filter into the machine when changing the filter, to solve the above-mentioned problem.

According to one aspect of the present invention, a filter cleaning apparatus is disclosed. The filter cleaning apparatus comprises: a driving force generating module, for generating a driving force; a cleaning module, for cleaning a filter; and a driving force delivering module, coupled to the driving force generating module and the cleaning module, for delivering the driving force from the driving force generating module to the cleaning module.

Moreover, according to another aspect of the present invention, a filter cleaning apparatus is also disclosed. The filter cleaning apparatus comprises: a cleaning roller, for cleaning a filter; and a driving force delivering module, coupled to the cleaning roller, for driving the cleaning roller to move on a surface of the filter for cleaning the filter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of a filter cleaning apparatus according to an embodiment of the present invention.

FIG. 2 is a perspective diagram illustrating the filter cleaning apparatus shown in FIG. 1 according to a first visual angle.

FIG. 3 is a perspective diagram illustrating the filter cleaning apparatus shown in FIG. 1 according to a second visual angle.

FIG. 4 is a front view of the filter cleaning apparatus shown in FIG. 2.

### DETAILED DESCRIPTION

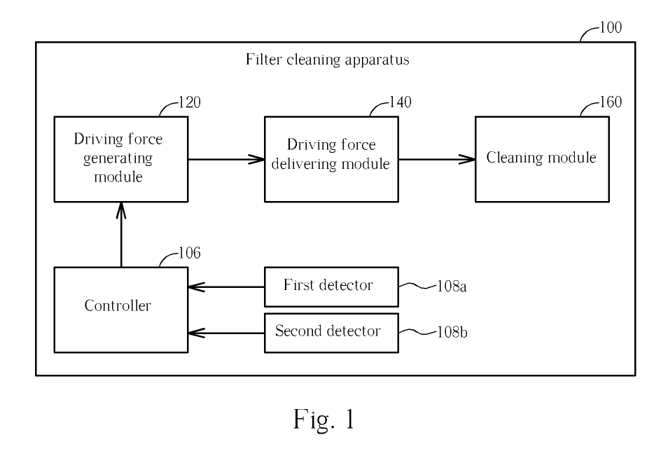

Please refer to FIG. 1. FIG. 1 is a simplified block diagram of a filter cleaning apparatus 100 according to an embodiment of the present invention. As shown in FIG. 1, the filter cleaning apparatus 100 has a driving force generating module 120, for generating a driving force; and a driving force delivering module 140, coupled to the driving force generating module 120 and a cleaning module 160, for delivering the driving force from the driving force generating module 120 to the cleaning module 160 to drive the cleaning module 160 to move on a surface of a filter. The cleaning module 160 is for cleaning the filter. The filter cleaning apparatus 100 further has a controller 106, a first detector 108a and a second detector 108b in this embodiment, wherein the first detector 108a and the second detector 108b are for detecting if the cleaning module 160 moves to a particular position, and the cleaning module 160 controls an on/off status of the driving force generating module 120 according to the detection results of the first detector 108a and the second detector 108b. The detailed structure and the operation of the filter cleaning apparatus 100 are as follows.

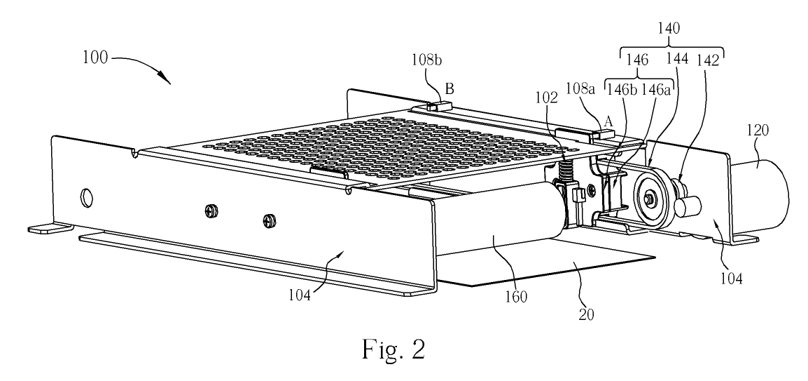

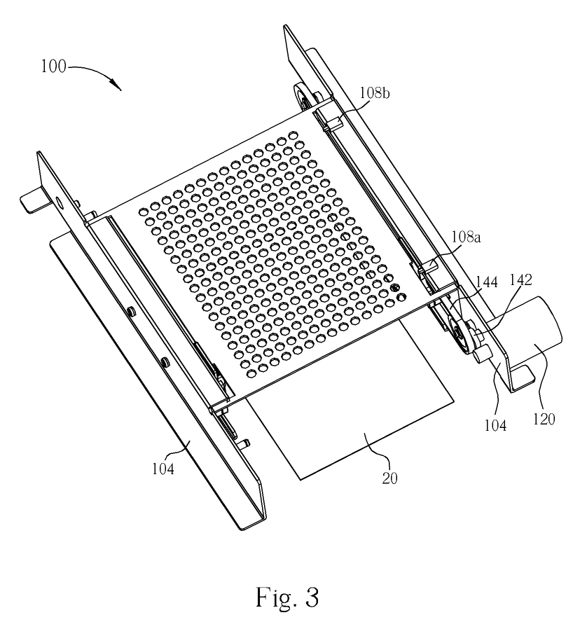

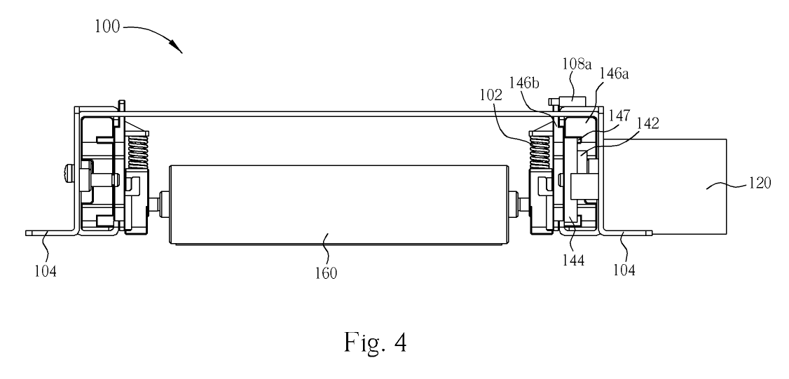

Please refer to FIG. 2, FIG. 3 and FIG. 4 together. FIG. 2 is a perspective diagram illustrating the filter cleaning apparatus 100 shown in FIG. 1 according to a first visual angle, FIG. 3 is a perspective diagram illustrating the filter cleaning apparatus 100 shown in FIG. 1 according to a second visual angle, and FIG. 4 is a front view of the filter cleaning apparatus shown 100 shown in FIG. 2. In this embodiment, the driving force generating module 120 is implemented by a motor, and the cleaning module 160 is implemented by a cleaning roller; however, these examples are for illustrative purposes only, and are not meant to be a limitation of the present invention. The driving force delivering module 140 comprises: at least a gear 142 coupled to the driving force generating module 120, a slide component set 146 and a belt 144 coupled to the gear 142 and the slide component set 146, wherein the slide component set 146 comprises a first slider 146a coupled to the belt 144 and a second slider 146b fixed onto the first slider 146a and further coupled to the cleaning module 160. Because the driving force generating module 120 is a motor, the rotation of the motor generates a driving force for driving the gear 142 to rotate, then the gear 142 drives the belt 144 to rotate. Because the first slider 146a of the slide component set 146 has a groove 147, the belt is embedded in the first slider 146a, and the second slider 146b of the slide component set 146 covers at least a part of the groove 147 for preventing the belt 144 from falling off the groove 147 of the first slider 146a. Therefore, the slide component set 146 can move with the movement of the belt 144 and drive the cleaning module 160 to move on the surface of the filter 20 accordingly, meaning that the driving force delivering module 140 delivers the driving force from the driving force generating module 120 (i.e. the motor) to the cleaning module 160 successfully.

The filter cleaning apparatus 100 further comprises a frame 104 on which the driving force generating module 120 and the driving force delivering module 140 can be fixed. Additionally, the cleaning module 160 is movably positioned on the frame 104. In other words, the cleaning module 160 moves along a direction defined by the frame 104. As shown in FIG. 2, both the first detector 108a and the second detector 108b are fixed on the frame 104 and disposed at a first predetermined position A and a second predetermined position B respectively for detecting the movement of the slide component set 146. In other words, the first detector 108a and the second detector 108b can detect the movement of the cleaning module 160. If the slide component set 146 moves to the first predetermined position A, the slide component set 146 will trigger the first detector 108a and then the controller 106 will stop (pause) the operation of the driving force generating module 120 (i.e. the motor). On the other hand, if the slide component set 146 moves to the second predetermined position B, the slide component set 146 will trigger the second detector 108b and then the controller 106 will control the operation of the driving force generating module 120 for returning the slide component set 146 to the first predetermined position A. That is to say, in this embodiment, the cleaning module 160 will move from the first predetermined position A to the second predetermined position B, and then move from the second predetermined position B back to the first predetermined position A in order to accomplish a filter cleaning cycle. However, this is not meant to be a limitation of the present invention. For example, in other embodiments of the present invention, when starting the operation of cleaning a filter, the cleaning module 160 only moves from the first predetermined position A to the second predetermined position B, or moves from the second predetermined position B to the first predetermined position A, which also achieves the goal of cleaning the filter 20.

In addition, in order to improve the efficiency of cleaning a filter, the filter cleaning apparatus 100 of the present invention further has an elastic component 102 having two sides respectively coupled to the second slider 146b and the cleaning module 160 for supplying the cleaning module 160 with an elastic force. This ensures that when the cleaning module 160 moves on the surface of the filter 20, the cleaning module 160 contacts with the surface of the filter 20. In this embodiment, the elastic component 102 is implemented by a spring. However, this is not meant to be a limitation of the present invention.

Please note that, in this embodiment, the filter cleaning apparatus 100 is located in a printer for cleaning the embedded filter 20. However, the filter cleaning apparatus 100 of the present invention can be applied to any apparatus having a filter installed thereon for cleaning the filter without dismantling the filter.

Compared with the prior art, when cleaning a filter, the filter cleaning apparatus of the present invention can allow the filter to recover its clean state by making use of the driving force delivering module and the cleaning module without requiring dismantling of the filter. In other words, the filter cleaning apparatus of the present invention can prevent the dust from dropping into the printer device when the filter is dismantled. As a result, the internal components will not be affected nor the print quality degraded due to dust.

Regarding the cleaning of the cleaning module 160 itself, a cleaning paper is further located under the cleaning module 160. For example, the cleaning paper can be located on one side or both sides of the plane where the filter lies for contacting with the cleaning module 160, wherein the stickiness of the cleaning paper is greater than that of the cleaning module 160, but the cleaning paper will have no glue remaining on the cleaning module 160 after cleaning is completed. Therefore, when the cleaning module 160 moves on the surface of the cleaning paper similar to the means of cleaning the filter, the dust on the cleaning module 160 will be transferred onto the cleaning paper due to the stickiness of the clean paper being greater than that of the cleaning module 160, thereby achieving the goal of cleaning the cleaning module 160. Please note that the position of the cleaning paper is for illustrative purposes only, and is not meant to be a limitation of the present invention. That is, by merely placing the cleaning paper at an appropriate position to contact with the cleaning module 160, the above-mentioned operational principle of cleaning the filter 20 by using the cleaning module 160 can be applied to accomplish the goal of cleaning.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A filter cleaning apparatus, comprising:
a driving force generating module, for generating a driving force;
a cleaning module, for cleaning a filter; and
a driving force delivering module, coupled to the driving force generating module and the cleaning module, for delivering the driving force from the driving force generating module to the cleaning module.

2. The filter cleaning apparatus of claim 1, wherein the driving force generating module is a motor.

3. The filter cleaning apparatus of claim 1, wherein the cleaning module is a cleaning roller.

4. The filter cleaning apparatus of claim 1, wherein the driving force generating module drives the cleaning module to move on a surface of the filter for cleaning the filter.

5. The filter cleaning apparatus of claim 4, wherein the driving force generating module is a motor, and the driving force delivering module comprises:
at least a gear, coupled to the motor, the gear being driven by the motor to generate a rotation;
a slide component set, coupled to the cleaning module; and
a belt, coupled to the gear and the slide component set, for driving the slide component set to move according to the rotation of the gear.

6. The filter cleaning apparatus of claim 5, wherein the slide component set comprises:
a first slider, having a groove, the belt being embedded in the groove for making the first slider move with a movement of the belt; and
a second slider, fixed onto the first slider and covering at least a part of the groove for preventing the belt from falling off the first slider.

7. The filter cleaning apparatus of claim 6, further comprising: an elastic component, having two sides coupled to the second slider and the cleaning module respectively, for supplying the cleaning module with an elastic force to make the cleaning module contact with the filter.

8. The filter cleaning apparatus of claim 7, wherein the cleaning module is a cleaning roller.

9. The filter cleaning apparatus of claim 7, wherein the elastic component is a spring.

10. The filter cleaning apparatus of claim 5, further comprising:
a frame, wherein the driving force generating module and the driving force delivering module are both fixed on the frame, and the cleaning module is movably positioned on the frame;
a controller, for controlling an on/off status of the driving force generating module; and
a first detector, fixed on the frame, for detecting a movement of the slide component set, wherein when the slide component set moves to a first predetermined position and then triggers the first detector, the controller stops an operation of the driving force generating module.

11. The filter cleaning apparatus of claim 10, further comprising:
a second detector, fixed on the frame, for detecting the movement of the slide component set, wherein when the slide component set moves to a second predetermined position and then triggers the second detector, the controller controls the driving force generating module to move the slide component set toward the first predetermined position.

12. The filter cleaning apparatus of claim 1, being positioned in a printer.

13. A filter cleaning apparatus, comprising:
a cleaning roller, for cleaning a filter; and
a driving force delivering module, coupled to the cleaning roller, for driving the cleaning roller to move on a surface of the filter for cleaning the filter.

14. The filter cleaning apparatus of claim 13, being positioned in a printer.
